(19) United States
(12) Patent Application Publication
(10) Pub. No.: US 2017/0342854 A1
(43) Pub. Date: Nov. 30, 2017

(54) Twin spool industrial gas turbine engine with variable inlet guide vanes

(71) Applicants: Barry J. Brown, Jupiter, FL (US); Joseph D. Brostmeyer, Jupiter, FL (US); Justin T. Cejka, Palm Beach Gardens, FL (US); Russell B. Jones, North Palm Beach, FL (US)

(72) Inventors: Barry J. Brown, Jupiter, FL (US); Joseph D. Brostmeyer, Jupiter, FL (US); Justin T. Cejka, Palm Beach Gardens, FL (US); Russell B. Jones, North Palm Beach, FL (US)

(21) Appl. No.: 15/137,248

(22) Filed: Apr. 25, 2016

Related U.S. Application Data
(60) Provisional application No. 62/257,361, filed on Nov. 19, 2015.

(51) Int. Cl. F01D 17/16; F02C 3/04; F01D 15/10; F04D 29/40; H02P 9/04; F01K 23/10; F02C 6/18

(52) U.S. Cl. CPC F01D 17/16; F01K 23/106; F02C 3/04; F02C 6/18; F04D 29/403; H02P 9/04; F01D 15/10; F05D 2220/32; F05D 2240/128; F05D 2270/023; F05D 2270/053; F05D 2270/061; F05D 2220/76

(57) ABSTRACT

A large frame heavy duty industrial gas turbine engine that can produce twice the power as a conventional single spool industrial engine, and can operate at full power during a hot day. The industrial engine includes a high spool that directly drives an electric generator at a synchronous speed of the electric power grid, a low spool with a low pressure turbine that drives a low pressure compressor from the exhaust gas from the high pressure turbine, where the low pressure compressor supplies compressed air to the high pressure compressor. Variable inlet guide vane assemblies are used in the low pressure turbine and the low pressure compressor so that the high spool can operate at full power even during a hot day. The low spool is designed to operate at a higher speed than at the normal temperature conditions so that a high mass flow can be produced for the high spool during the hot day conditions.

### CROSS-REFERENCE TO RELATED APPLICATIONS

This application claims the benefit to U.S. Provisional Application No. 62/257,361 filed on Nov. 19, 2015 and entitled TWIN SPOOL INDUSTRIAL GAS TURBINE ENGINE WITH VARIABLE INLET GUIDE VANES.

### GOVERNMENT LICENSE RIGHTS

This invention was made with Government support under contract number DE-FE0023975 awarded by Department of Energy. The Government has certain rights in the invention.

### BACKGROUND OF THE INVENTION

### Field of the Invention

The present invention relates generally to a twin spool industrial gas turbine engine, and more specifically to an engine in which the low spool and the high spool can be operated at different speeds/variable vane setting to optimize power during hot day operation.

### Description of the Related Art Including Information Disclosed Under 37 CFR 1.97 and 1.98

A large frame, heavy duty industrial gas turbine engine is used in a power plant to drive an electric generator and produce electrical power. In the USA, the electrical power grid operates at 60 Hertz and thus the industrial engine drives a 60 Hertz electric generator that operates at 3,600 rpm. The engine directly drives the electric generator without using a gear box in order to increase efficiency of the engine, since a gear box would reduce the efficiency around 1%. A typical industrial gas turbine engine of 300 MW is designed to operate at the 3,600 rpm to be in synchronous speed with the 60 Hertz electric generator. The engine is designed to produce the largest mass flow through the engine and thus produce the maximum power. the industrial engine is designed for what is referred to as an ISO day, which for example would be at a certain outside air or ambient temperature of 60 degrees F. when the outside air temperature is much higher, for example 90 degrees F., the air mass is less dense and thus the mass flow through the industrial engine will be less, resulting is less power produce by the industrial engine and therefore less electrical power produced by the electric generator. The same issues arise for an industrial engine designed for the European market which operates at 50 hertz with an engine and generator operating at 3,000.

### BRIEF SUMMARY OF THE INVENTION

A large frame heavy duty industrial gas turbine engine capable of operating within a broad range of outside air temperature while still maintaining full power output in order to drive an electric generator as full power. The industrial gas turbine engine includes a high spool with a separately operable low spool or turbocharger that produces compressed air supplied to the high pressure compressor of the high spool. The high spool includes a high pressure compressor, a combustor, and a high pressure turbine that directly drives an electric generator and operates continuously at a synchronous speed of the electrical power grid such as 60 Hertz or 50 hertz. The low spool or turbocharger includes a low pressure turbine that drives a low pressure compressor. The HPC, the LPT, and the LPC each includes a variable inlet guide vane assembly so that the speed of the electric generator can be operated continuously at the synchronous speed under various ambient temperatures by regulating one or more of the variable inlet guide vane assemblies.

The low spool or turbocharger is designed to operate at a higher speed than the normal operating speed of the engine at the designed for ambient temperature conditions. For a hot day (above the normal ambient temperature design condition), the low spool will need to operate at a higher speed in order to supply a higher mass flow to the high spool in order to operate at the synchronous speed of the generator during the hot day conditions.

Because of the use of the low spool as being a turbocharger for the high spool, and the use of variable inlet guide vanes for the low pressure turbine and the low pressure compressor, the industrial engine of the present invention is capable of operating at twice the power output as any known industrial gas turbine engine. At the present time, the largest known industrial engine for the 60 hertz market has a maximum power output of around 350 MW and for the 50 hertz market at around 500 MW. The twin spool turbocharged industrial gas turbine engine of the present invention can produce in excess of 500 MW for the 60 hertz engine and in excess of 720 MW for the 50 hertz engine.

### BRIEF DESCRIPTION OF THE SEVERAL VIEWS OF THE DRAWINGS

FIG. 1 shows a cross section view of a twin spool industrial gas turbine engine with variable inlet guide vanes according to the present invention.

FIG. 2 shows the turbocharged industrial gas turbine engine of FIG. 1 in a combined cycle power plant with a HRSG.

### DETAILED DESCRIPTION OF THE INVENTION

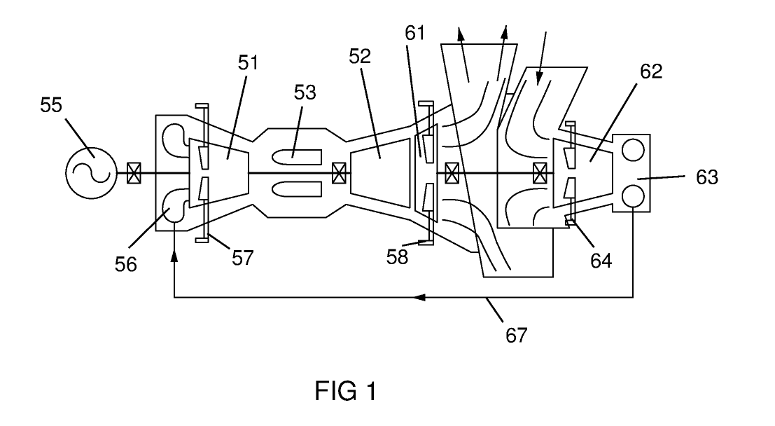

The present invention is a twin spool industrial gas turbine engine used for electrical power production where the engine can operate at full power even on a hot day when the air temperature is well above the engine design temperature. FIG. 1 shows the engine with a high spool that directly drives (without a gear box) an electric generator 55 which operates at 60 Hertz for US market or 60 Hertz for European market. The high spool includes a high pressure compressor (HPC) 51 connected by the high spool shaft to a high pressure turbine (HPT) 52. A high pressure combustor 53 is connected between the HP compressor 51 and the HP turbine 52. A variable inlet guide vane (IGV) assembly 57 is positioned upstream of the high pressure compressor 51. The twin spool turbocharged industrial gas turbine engine of the present invention can produce in excess of 500 MW for the 60 hertz engine and in excess of 720 MW for the 50 hertz engine.

A low spool with a low pressure turbine (LPT) 61 is connected by the low spool shaft to a low pressure compressor (LPC) 62. The low spool functions as a turbocharger for the high spool engine. A variable inlet guide vane assembly 58 is positioned upstream of the low pressure turbine 58. Another variable inlet guide vane assembly 64 is positioned upstream of the low pressure compressor 62. The high spool can operate separately from the low spool since the high spool does not rotate outside (concentric with) of the low spool as in a typical twin spool gas turbine engine like those that power an aircraft. The low pressure compressor 62 includes an outlet volute 63 where the compressed air flows into. The compressor outlet volute 63 is connected to an inlet volute 56 to the high pressure compressor 51 through a compressed air connection 67 such as a tube or pipe.

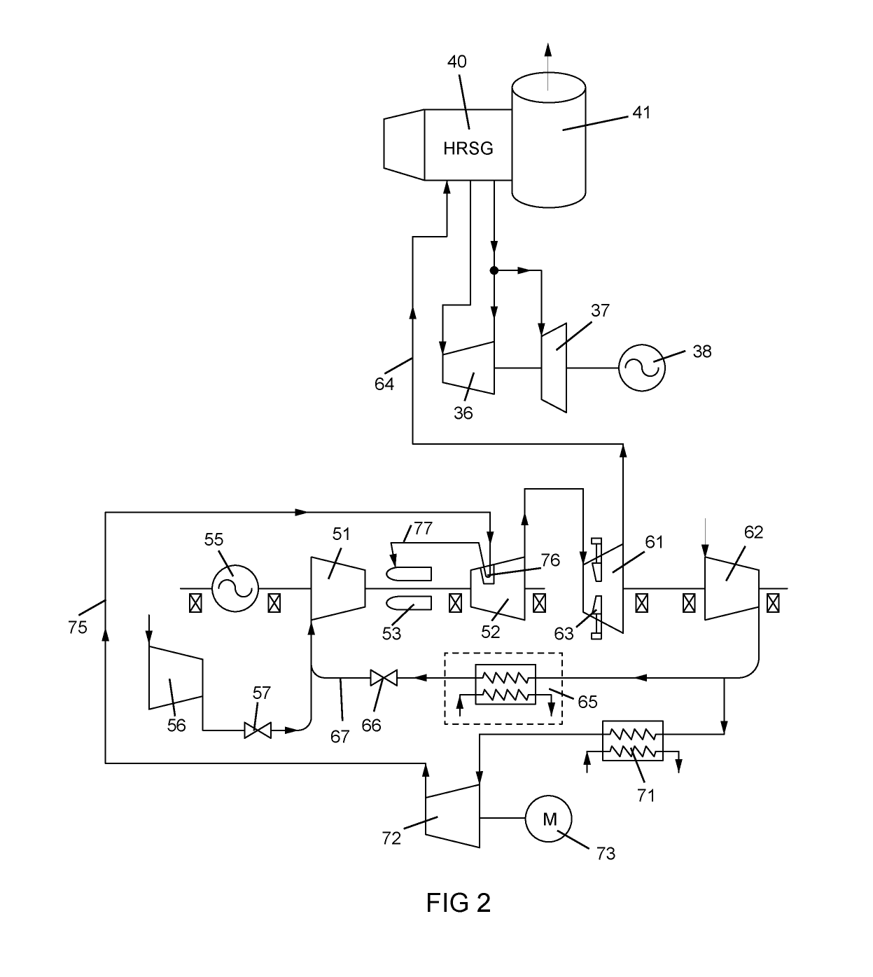

FIG. 2 shows the twin spool turbocharged industrial gas turbine engine of FIG. 1 in a combined cycle power plant where a HRSG (Heat Recovery Steam Generator) 40 is used to produce steam from the turbine exhaust that is used to drive a second electric generator 38. Hot turbine exhaust flow from the low pressure turbine 61 flows through line 64 and into the HRSG 40 to produce steam that flows through a high pressure steam turbine 36 and then a low pressure steam turbine 37 that both drive the second electric generator 38. The cooler exhaust from the HRSG 490 flows out the stack 41. An intercooler 65 can be sued to cool the compressed air from the low pressure compressor 62 in the bypass line 67 with a flow control valve 66. A turbine airfoil cooling circuit can also be used in which some of the compressed air from the low pressure compressor 62 is passed through a second intercooler 71 and then a compressor 72 driven by a motor 73 to increase the pressure so that the turbine airfoil 76 can be cooled and have enough pressure left over to flow into the combustor 53. Lines 75 and 77 channel the cooling air to and from the air cooled turbine airfoils such as the stator vanes. A boost compressor 56 with flow control valve 57 can be used to pressurize air for the high pressure compressor 51.

In operation, compressed air from the HPC 51 flows into the combustor 53 where fuel is burned to produce a hot gas stream that flows into the HPT 52. Hot exhaust from the HPT 52 then flows into the LPT 61 that is used to drive the LPC 62. Compressed air from the LPC 62 flows through the tube 67 and into the inlet of the HPC 51. The high spool drives the electric generator 55 and produces electricity. The three sets of variable inlet guide vanes 57, 58, 64 are used to regulate the flow into the two compressors 51 and 62 and the LPT 61.

On a standard (iso) day where the ambient outside temperature is 60 degrees F., the engine will operate at full power as designed. However, on a hot day (such as 90 degrees F.), the density of the air is less and therefore with a conventional engine, flow will be low and the engine will operate at a lower power level. In a single spool industrial engine, only one shaft is used and that shaft drives the electric generator. Thus, the single spool industrial engine is designed to operate at one speed during cold or hot days but not both, and that speed is the speed of the electric generator which is 60 hertz in the USA market and 50 hertz in European market. On a hot day (90 degrees F.), the single spool industrial engine will operate at the design speed but with less power because of the lower density air and thus lower volume flow through the engine. With a conventional two spool industrial engine, limitations to the compressor 53, LPC 62, HPT 52 and/or LPT 61 structural design and absence of a turbine variable inlet guide vane will not allow the physical speed of the gas generator compressor/turbine to be increased to the level required to maintain iso day (the design speed) engine flow/power.

In the twin spool engine of the present invention, the high spool is used to drive the electric generator 55 and thus operates continuously (3,600 rpm for a 60 Hertz engine or 3,000 rpm for a 50 Hertz engine) during different ambient temperatures at the designed speed of the electric generator 55. On a hot day, to make up for the less dense air, the low spool with the low pressure compressor 62 is operated at a higher speed so that more compressed air is passed into the high pressure compressor 51 to keep the power output consistent. The IGV 58 to the LPT 61 can be closed to increase the pressure ratio across the LPT 61 and therefore increase the output power of the LPT 61 to drive the LPC 62 at the higher speed and produce more compressed air for the HPC 51. A key component of this invention is to design the LPT so that its physical speed (rpm) can be increased to higher levels when the ambient temperature (outside air temperature) is greater than iso day conditions without exceeding structural limits. Thus, the low spool is designed to operate at a higher speed than the normal speed at the designed for ambient temperature conditions. For example, the low spool is designed to operate at the 90 degrees F. condition as well as the 60 degrees F. condition so that the low spool can operate at the higher speed during the hot days (90 degrees F.) so that the high spool can operate at full power. Thus, the arrangements of the IGV assemblies 57, 58, 64 and their operation can be used to produce a constant mass flow through the high spool so that the full power of the engine is used to drive the electric generator 55.

The LPC and LPT of the engine are designed for a physical speed higher than required for the standard iso operating temperature (60 degrees F.) so that the normal mass flow will flow through the engine at hot day conditions and drive the electric generator at full power. On a hot day (say 90 degrees F.), the flow through the engine is maintained at iso day levels by varying the IGVs to increase the speed of the low spool relative to iso day while maintaining the speed of the high spool at the electric generator design speed . Thus, the engine will operate at full power regardless of the ambient outside air temperature.

I claim the following:

1. A large frame heavy duty industrial gas turbine engine for electric power production comprising:
a high spool with a high pressure compressor, a combustor, and a high pressure turbine;
an electric generator directly driven by the high spool at a speed synchronous with a local power grid to produce electrical power;
a low spool with a low pressure turbine and a low pressure compressor;
the low spool and the high spool being connected such that turbine exhaust from the high pressure turbine drives the low pressure turbine;
a compressed air line connecting the low pressure compressor to the high pressure compressor to supply compressed air to the high pressure compressor;
a first variable inlet guide vane assembly for the low pressure turbine; and,
a second variable inlet guide vane assembly for the low pressure compressor; and,
the variable inlet guide vane assembly for the low pressure turbine can regulate a power output to drive the low pressure compressor so that the high spool can operate at full power during a normal temperature day and a hot temperature day.

2. The large frame heavy duty industrial gas turbine engine of claim 1, and further comprising:
a third variable inlet guide vane assembly for the high pressure compressor.

3. The large frame heavy duty industrial gas turbine engine of claim 1, and further comprising:
the low spool is designed to operate at a speed higher than required for the standard iso operating temperature so that the normal mass flow will flow through the engine at hot day conditions and drive the electric generator at full power.

4. The large frame heavy duty industrial gas turbine engine of claim 1, and further comprising:
the low spool does not rotate within the high spool.

5. The large frame heavy duty industrial gas turbine engine of claim 1, and further comprising:
the electric generator is a 60 hertz generator; and,
the industrial gas turbine engine is capable of producing 500 MW.

6. The large frame heavy duty industrial gas turbine engine of claim 1, and further comprising:
the electric generator is a 50 hertz generator; and,
the industrial gas turbine engine is capable of producing 720 MW.
